(19) United States
(12) Patent Application Publication
(10) Pub. No.: US 2025/0278323 A1
(43) Pub. Date: Sep. 4, 2025

(54) PROCEDURE PROCESSING METHOD, MEDIUM AND ELECTRONIC DEVICE

(71) Applicant: Beijing Zitiao Network Technology Co., Ltd., Beijing (CN)

(72) Inventor: Yu LU, Beijing (CN)

(21) Appl. No.: 19/094,607

(22) Filed: Mar. 28, 2025

(30) Foreign Application Priority Data
Mar. 28, 2024 (CN) 202410371419.1

(51) Int. Cl. G06F 9/54; G06F 9/48

(52) U.S. Cl. CPC G06F 9/547; G06F 9/4843

(57) ABSTRACT

A procedure processing method, a medium, and an electronic device are provided, the method includes: determining at least two target templates; configuring, by using node configuration interfaces respectively corresponding to the target templates, target nodes respectively corresponding to the target templates; generating a target procedure based on at least two target nodes; and executing the target procedure by using a procedure engine.

### CROSS-REFERENCE TO RELATED APPLICATION

This application claims the priority of Chinese Patent Application No. 202410371419.1, filed on Mar. 28, 2024, the disclosure of which is incorporated by reference herein in its entirety as part of the present application.

### TECHNICAL FIELD

Embodiments of the present disclosure relate to the field of computer processing technologies, and in particular, to a procedure processing method, a medium and an electronic device.

### BACKGROUND

A procedure is used to execute processing of one or more nodes in a specific sequence, each node may represent one section. For example, a procedure A1 sequentially includes processing of a node B1, processing of a node B2, and processing of a node B3, so that a process of executing the procedure A1 is sequentially executing the processing of the node B1, the processing of the node B2, and the processing of the node B3.

In the prior art, the above procedure may be created and maintained by a user, specifically including but not limited to: setting a plurality of nodes included in the procedure, setting a sequence in which the plurality of nodes are executed in the procedure, and setting processing logic of each node.

However, the above solution has a problem of low efficiency.

### SUMMARY

Embodiments of the present disclosure provide a procedure processing method, a medium and an electronic device, to improve procedure creation efficiency.

According to a first aspect, at least one embodiment of the present disclosure provides a procedure processing method. The method includes:
determining at least two target templates;
configuring, by using node configuration interfaces respectively corresponding to the target templates, target nodes respectively corresponding to the target templates;
generating a target procedure based on at least two target nodes; and
executing the target procedure by using a procedure engine.

According to a second aspect, at least one embodiment of the present disclosure provides a procedure processing apparatus. The apparatus includes:
a target template determining module, configured to determine at least two target templates;
a node configuration module configured to, configure, by using node configuration interfaces respectively corresponding to the target templates, target nodes respectively corresponding to the target templates;
a procedure generation module, configured to generate a target procedure based on at least two target nodes; and
a procedure execution module, configured to execute the target procedure by using a procedure engine.

According to a third aspect, at least one of the present disclosure provides an electronic device. The electronic device includes: at least one processor and a memory.

The memory stores computer-executable instructions.

The at least one processor executes the computer-executable instructions stored in the memory, to cause the electronic device to implement the method according to the first aspect.

According to a fourth aspect, at least one embodiment of the present disclosure provides a computer-readable storage medium storing computer-executable instructions, when the computer-executable instructions are executed by a processor, a computing device is caused to implement the method according to the first aspect.

According to a fifth aspect, at least one embodiment of the present disclosure provides a computer program product including a computer program, when the computer program is executed by a processor, the method according to the first aspect is implemented.

### BRIEF DESCRIPTION OF DRAWINGS

In order to describe the technical solutions in embodiments of the present disclosure or in the prior art more clearly, the accompanying drawings for describing the embodiments or the prior art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a schematic diagram of a structure and an execution sequence of a procedure according to at least one embodiment of the present disclosure;

FIG. 2 is a flowchart of steps of a procedure processing method according to at least one embodiment of the present disclosure;

FIG. 3 is a schematic diagram of splitting a target procedure according to at least one embodiment of the present disclosure;

FIG. 4 is a schematic diagram of a process of generating a target procedure according to at least one embodiment of the present disclosure;

FIG. 5 is a schematic diagram of a generation result of a target procedure according to at least one embodiment of the present disclosure;

FIG. 6 is a flowchart of steps of another procedure processing method according to at least one embodiment of the present disclosure;

FIG. 7 is a block diagram of a structure of a procedure processing apparatus according to at least one embodiment of the present disclosure; and

FIG. 8 is a block diagram of a structure of an electronic device according to at least one embodiment of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

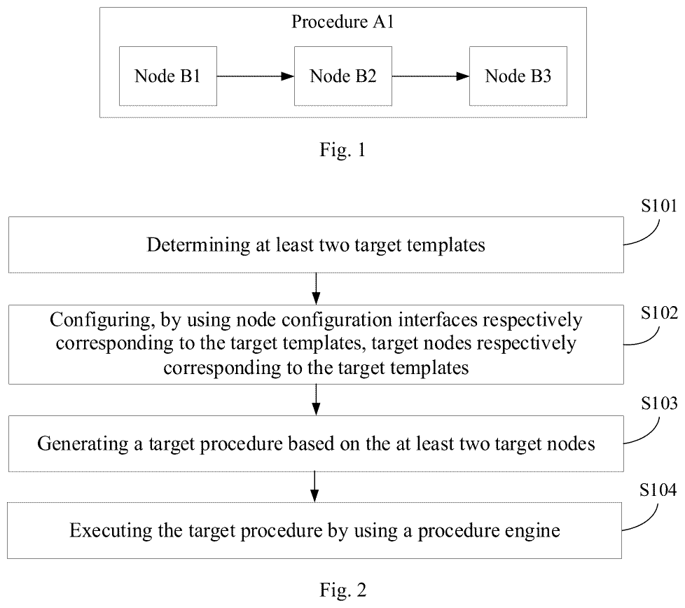

The embodiments of the present disclosure are used for creating and executing a procedure intelligently, the procedure includes a plurality of sequentially executed nodes, and each node is used for one processing process, for example, one type of processing process. The procedure in the embodiments of the present disclosure may be a procedure of any function in any scenario. FIG. 1 is a schematic diagram of a structure and an execution sequence of a procedure according to at least one embodiment of the present disclosure. As shown in FIG. 1, a procedure A1 includes nodes B1, B2, and B3 that are sequentially executed. Specifically, a process of executing the procedure A1 is: executing the node B1 first, then executing the node B2, and finally executing the node B3.

In some solutions, the above procedure is created by a user. In such a method, the user is required to set implementation logic of each node in the procedure, and different nodes correspond to operations of different systems, resulting in relatively low procedure creation efficiency. In addition, a manual operation is required to execute the procedure, resulting in relatively low procedure execution efficiency.

In order to solve the above problem, in the embodiments of the present disclosure, a node may be configured based on a template, to generate a procedure. In this case, the user needs to enter only a small amount of information in a node configuration interface of the template, so that operation complexity of the user can be reduced and procedure creation efficiency can be improved.

The technical solutions of the embodiments of the present disclosure and how to solve the above technical problem by using the technical solutions of the present disclosure are described in detail below by using specific embodiments. The following several specific embodiments may be combined with each other, and details about same or similar concepts or processes may not be described in some embodiments again. The embodiments of the present disclosure are described below with reference to the accompanying drawings.

FIG. 2 is a flowchart of steps of a procedure processing method according to at least one embodiment of the present disclosure. As shown in FIG. 2, the procedure processing method includes the following steps.

S101: determining at least two target templates.

The target template herein is any template, the template is preset and used to generate a node, and a node configuration interface of the target template is used to configure a node corresponding to the target template. The target template may be selected from a plurality of preset templates and is used during current procedure creation.

In some implementations, the target template may be selected from one or more displayed templates. Specifically, first, at least one template that meets a preset condition is displayed; and then, at least one target template selected by a current user from the at least one template is received.

Each template corresponds to a plurality of attributes, and the attributes of each template may include, but are not limited to: a template identifier, a space to which the template belongs, a type of the template, whether the template is visible to the user, a display sequence number of the template, a maintainer of the template, description information of the template, called-interface information of the template, a node configuration interface of the template, creation time of the template, and modification time.

The template identifier is used to uniquely indicate a template, and may be a template name, a unique number, or the like. Based on the template identifier, the preset condition of displaying the template may be set as follows: the template identifier of the template is a target template identifier. In this case, a template with the target template identifier may be displayed, so that the user selects the target template therefrom. The target template identifier is any template identifier entered by the user, to quickly find the template corresponding to the target template identifier from all templates as the target template, so that operation efficiency of the user can be improved.

The space to which the template belongs may correspond to a project, an application scenario, or the like, to indicate that the template belongs to the project or the application scenario. The space can facilitate management and isolation of the template. Specifically, when a user is included in a user set of the space, the user may use the template in the space; or when a user is not included in a user set of the space, the user cannot use the template in the space. In this case, an access permission for the template may be managed by using the space, which helps improve security of the template.

On the basis that each template corresponds to a space to which the template belongs, in the embodiments of the present disclosure, a template belonging to a target space may be used as the preset condition of displaying the template. That is, the template in the target space may be selected from all the templates for display, so that the user selects the target template therefrom.

The above target space may be any space selected by the user from spaces of all the templates, or may be a default space. When each space has a supported user set, the target space is a space of which a user set includes the current user. The user set of each space includes at least one user that can use the space. Therefore, a process of determining the target space includes: first, obtaining at least one candidate space of which the user set includes the current user; and then, receiving the target space selected by the current user from the at least one candidate space. It can be learned that the target space is any space selected by the current user from spaces for which the current user has an access permission. Therefore, it can be ensured that the template selected according to the target space is a template that is available to the current user, thereby improving template availability.

Types of the templates may be flexibly classified based on an actual application scenario. Specifically, the types of the templates may be classified into N types that are respectively represented by N enumerated values. For example, when the N types include two types: a development type and a business type, the two types may be represented by two enumerated values 0 and 1. The development type is used to indicate that a corresponding template is used for a development process and is a template used by a developer. The business type is used to indicate that a corresponding template is a template used by a user.

Based on the type of the template, the preset condition of displaying the template may be set as follows: the type of the template is a target type. The target type is any one of all types of the templates. For example, the target type may be the above business type by default. In this embodiment of the present disclosure, the templates may be classified based on the types of the templates, so that the user can conveniently filter the templates based on the types, thereby improving efficiency in selecting the target template.

The templates are classified into a template visible to the user and a template invisible to the user based on whether the template is visible to the user. The template visible to the user is used to indicate that the template can be displayed to the user for use by the user. The template invisible to the user is not displayed to the user, to prevent the user from using the template.

Based on whether the template is visible to the user, the preset condition of displaying the template may be set as follows: the template is visible to the user. In this embodiment of the present disclosure, the template visible to the user is displayed for selection by the user, which can ensure that the target template selected by the user is a template available to the user, and can avoid recommendation of redundant templates, thereby improving availability of the target template.

The display sequence number of the template is used to uniquely indicate a display sequence of a template. The display sequence number may be set when the template is configured, and is stored as an attribute of the template. Therefore, each time one or more templates are displayed, the display sequence number of each template may be obtained, to arrange a plurality of templates in descending or ascending order based on display sequence numbers for display.

In some conventional implementations, the display sequence number may be set by the user, or may be automatically generated in a template setting sequence. A template that is set first corresponds to a relatively small display sequence number, and a template that is set later corresponds to a relatively large display sequence number. For example, the display sequence number counts from 1, and each time a template is set, the display sequence number is increased by 1.

It can be understood that, in this embodiment of the present disclosure, the templates may be sequentially displayed, thereby improving orderliness of template display, facilitating the user in quickly finding the target template, and improving the operation efficiency of the user.

The maintainer of the template may be understood as a person responsible for the template. When the template is created, a creator may be set as the maintainer of the template by default, and a modification of the maintainer is supported. A target maintainer may be any maintainer entered by the user, so that a template of the target maintainer can be selected from all the templates, to quickly select the target template therefrom, thereby improving the operation efficiency of the user.

The description information of the template is used to describe basic information of the template by using text, and the basic information may include a function, a usage scenario, and the like of the template.

The called-interface information of the template is used to indicate information about an interface to be called when a processing process of a node corresponding to the template is executed. The processing process of the node is executed based on the called-interface information during execution of the node corresponding to the template.

The creation time of the template is set based on current time when the template is created. In some implementations, the preset condition of displaying the template may be set based on the creation time: the creation time of the template is target creation time, so that the template with the target creation time set by the user is displayed, thereby facilitating the user in filtering the templates based on the creation time.

The modification time of the template is set based on current time each time the template is modified. Therefore, the modification time is the time of a last modification. In some implementations, the preset condition of displaying the template may be set based on the modification time: the modification time of the template is the target modification time, so that the template with the target modification time set by the user is displayed, thereby facilitating the user in filtering the templates based on the modification time.

In conclusion, the preset condition to be met by the displayed template in the embodiments of the present disclosure includes at least one of the following: the template belonging to the target space, the type of the template being the target type, the template being visible to the user, the template belonging to the target maintainer, the template identifier of the template being the target template identifier. In this case, some templates are filtered, based on the above preset condition, for selection by the user, thereby avoiding provision of a template unavailable to the user, and ensuring the availability of the target template. In addition, the number of templates provided to the user may be further reduced, thereby improving efficiency in selecting the target template by the user.

In some implementations, the displaying at least one template that meets a preset condition includes: first, obtaining a display sequence number respectively corresponding to the at least one template; and then, sequentially displaying, based on the display sequence number respectively corresponding to the at least one template, the at least one template that meets the preset condition.

It can be learned from the above descriptions that display sequence numbers are used to indicate a display sequence of templates, to display the templates in a preset sequence.

In some implementations, the node configuration interface of the above target template may alternatively be preconfigured by the user. Specifically, before the at least two target templates are determined, interface information entered by the user may be received, the interface information is used to describe at least one control in the node configuration interface of the target template, and each of the at least one control is used to configure one type of node information. Then, the node configuration interface of the target template is generated based on the interface information. In this case, the control in the node configuration interface may be flexibly configured based on the interface information entered by the user, to flexibly configure the node configuration interface. Configuration of the node configuration interface is the configuration of a corresponding template.

For each control in the node configuration interface, the interface information includes at least one of the following: an information identifier of node information received by the control, a type of the control, a title of the control, all options of the control, an interface for obtaining the option, a default option of the control, whether the node information received by the control is mandatory, description information of the control, or a display sequence number of the control.

The information identifier is used to uniquely indicate a control.

The type of the control may include, but is not limited to: a plurality of types, such as an input box, a text box, a pull-down box, a multi-choice box, a single-choice box, and a user selection box.

The title of the control is used to indicate, to the user, content to be entered by using the control.

The interface for obtaining option is provided in the background. When the node configuration interface is to be loaded, the interface may be called first to obtain an option of the control and the option is displayed in the control, so that the user can select an option therefrom as node information entered by the user.

The description information of the control is used to simply describe the control, including but not limited to describing a usage scenario, a function, and the like.

The display sequence number of the control is used to indicate a location of the control in the node configuration interface. This can ensure that all controls in the node configuration interface are sequentially arranged in the node configuration interface for display.

S102: Configuring, by using node configuration interfaces respectively corresponding to the target templates, target nodes respectively corresponding to the target templates.

Configuration of the target node may be understood as entering node information of the target node, to generate the target node based on the entered node information. Each target template corresponds to one node configuration interface, the node configuration interface is used to configure the target node corresponding to the target template.

In some implementations, the target node may be configured by using the following process: first, for each of the target templates, the node configuration interface corresponding to the target template is displayed; then, node information entered by a current user in the node configuration interface is received; and finally, the target node corresponding to the target template is generated based on the target template and the node information.

It can be understood that after determining the target template, the user may operate target templates one by one, to display the node configuration interface of each of the target templates, and to complete the configuration of a corresponding target node in the node configuration interface. An attribute corresponding to the target node is consistent with an attribute of the corresponding target template.

S103: generating a target procedure based on the at least two target nodes.

The target procedure includes sequentially executing the at least two target nodes. A sequence of the target nodes in the target procedure may be set by the user. Specifically, a sequence input instruction is received. Then, the sequence of the at least two target nodes in the target procedure is determined based on the sequence input instruction.

In an example, after selecting target templates, the user may set a first sequence between the target templates, and then may configure a corresponding target node in a node configuration interface corresponding to each target template. In this case, the first sequence may indicate a second sequence of the target nodes corresponding to the target templates in the target procedure, so that the target procedure can be generated based on the second sequence and the target nodes.

In another example, after selecting target templates, the user may first configure a corresponding target node in a node configuration interface corresponding to each target template, and then set a second sequence of the target nodes, to generate the target procedure based on the second sequence and the target nodes.

It can be learned from the above descriptions that the sequence of the target nodes in the target procedure may be flexibly set by the user, to flexibly set the sequence of the target nodes based on dynamic configuration of the target nodes. This can further improve flexibility of the target procedure.

The above target procedure may have the following attributes: a procedure identifier, a space to which the target procedure belongs, a procedure name entered by the user, a procedure engine identifier, a procedure parameter, an execution condition, a directed acyclic graph, interface calling information, a maintainer, creation time, and modification time.

The procedure identifier of the target procedure is used to uniquely indicate a procedure, and may be entered by the user during creation of the target procedure.

The space to which the target procedure belongs is the same as a space to which each target node included in the target procedure belongs.

The procedure name of the target procedure may be entered by the user during the creation of the target procedure.

The procedure engine identifier of the target procedure is used to uniquely indicate a procedure engine for executing the target procedure, and is also entered by the user during the creation of the target procedure.

The procedure parameter of the target procedure is used to indicate an execution scenario corresponding to the procedure, for example, timeout time or a region in which the target procedure is located.

The directed acyclic graph (DAG) of the target procedure is used to indicate the target node included in the target procedure and the sequence of target nodes in the target procedure. For example, FIG. 1 may be a directed acyclic graph of a target procedure A1, and is used to indicate that the target procedure A includes target nodes B1, B2, and B3 that are sequentially arranged. The directed acyclic graph of the target procedure may be used to restore display of the target procedure when a panel is newly opened.

The interface calling information of the target procedure may be obtained by splicing interface calling information of target nodes in the target procedure. The interface calling information of the target node is generated during generation of the target node, based on interface calling information of the target template and the node information entered by the user. The interface calling information of the target template includes a placeholder, and the node information entered by the user may be replaced with a corresponding placeholder, to obtain the interface calling information of the target node.

The maintainer of the target procedure may be set as a creation user of the target procedure by default during the creation of the target procedure, or may be modified subsequently.

The creation time of the above target procedure may be the time of generating the target procedure based on the target node.

The modification time of the above target procedure may be the time of modifying the target procedure, and may be updated to the current time each time the target procedure is modified.

S104: executing the target procedure by using a procedure engine.

It can be learned from the above descriptions that the attribute of the target procedure includes the procedure engine identifier of the target procedure. Therefore, the procedure engine herein may be a procedure engine corresponding to the procedure engine identifier in the target procedure. Certainly, the procedure engine herein may alternatively be a procedure engine shared by all target procedures.

Specifically, during the creation of the target procedure, an execution strategy of the target procedure may be set, including but not limited to: periodic execution or event-triggered execution. When the execution strategy is periodic execution, an execution period further needs to be set, so that a scheduling system may schedule the target procedure for execution each time the execution period arrives. When the execution strategy is event-triggered execution, the target procedure may be executed each time the event occurs. In this case, the execution strategy may be preconfigured, and the target procedure is executed by using the procedure engine. This can implement an unattended procedure execution scenario and reduce labor costs.

In some implementations, a process of executing the target procedure by using the procedure engine may include: first, determining a target space to which the target procedure belongs; then, obtaining account information corresponding to the target space; and finally, calling the procedure engine through the account information to run the target procedure.

The target space is a space to which the target procedure belongs, and is prestored as an attribute of the target procedure. The account information may be understood as permission information for calling the procedure engine. In this embodiment of the present disclosure, the account information may be set through a space, to allow permission control for calling of the procedure engine, so that the procedure engine is compliantly called.

It should be noted that after the target procedure is created, the target procedure may be represented by using first data, then the first data is converted into second data that can be identified by the procedure engine, and the second data is stored, so that the procedure engine subsequently can execute the target procedure represented by the second data one or more times. For example, the first data and the second data are both in a JavaScript object notation (JSON) format, but have different specific representation manners.

In a process of calling the procedure engine to run the target procedure, the target procedure may be split into at least one target sub-procedure based on a branch of the target procedure, the number of the target sub-procedure(s) is consistent with the number of the branch(es); then, a target subtask is generated based on each of the at least one target sub-procedure; and finally, the target subtask is executed by using the procedure engine, different target subtasks corresponding to the target procedure are executed by different threads of a process of the target procedure. It may alternatively be understood as each target sub-procedure corresponding to one branch.

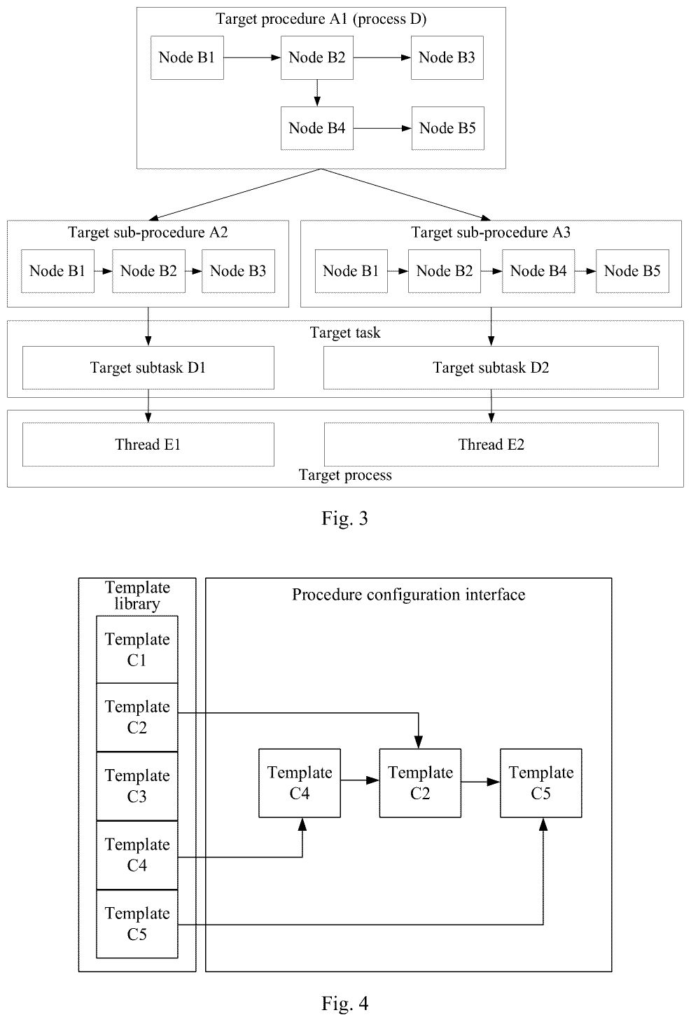

FIG. 3 is a schematic diagram of splitting a target procedure according to at least one embodiment of the present disclosure. As shown in FIG. 3, a target procedure A1 includes nodes B1, B2, B3, B4, and B5. During execution of the target procedure, processing processes of the nodes B1 and B2 are first sequentially executed. Then, a processing process of the node B3 is executed while processing processes of the nodes B4 and B5 are executed. It can be seen that the processing process of the node B3 is executed in parallel with the processing processes of the nodes B4 and B5. The node B3 forms one branch, and the nodes B4 and B5 form another branch.

Therefore, as shown in FIG. 3, the target procedure A1 may be split into two target sub-procedures A2 and A3 based on the two branches. The target sub-procedure A2 includes the nodes B1, B2, and B3, and the target sub-procedure A3 includes the nodes B1, B2, B4, and B5. It can be seen from FIG. 3 that a sequence of executing the nodes in the target sub-procedure obtained through splitting is consistent with a sequence of executing the nodes in the target procedure.

After a plurality of target sub-procedures are obtained through splitting, one target subtask may be generated for one target sub-procedure, N branches correspond to N target sub-procedures, and N target sub-procedures correspond to N target subtasks. Therefore, a process of executing each target procedure may be split into processes of executing a plurality of target subtasks in parallel. This can effectively improve efficiency in executing the target procedure and ensure independence of different target subtasks.

As shown in FIG. 3, the target sub-procedure A2 and the target sub-procedure A3 respectively correspond to target subtasks D1 and D2, and the target subtasks D1 and D2 form a target task. The target subtask D1 is used to execute the target sub-procedure A2, and the target subtask D2 is used to execute the target sub-procedure A3. In addition, the target subtask D1 is executed by a thread E1 of a target process, and the target subtask D2 is executed by a thread E2 of the target process. The target process may be understood as a process corresponding to the target task or a process of the target procedure. The target process is the process corresponding to the target task.

The above target subtask may correspond to at least one of the following attributes: a task identifier of the target subtask, a second procedure identifier of the target sub-procedure corresponding to the target subtask, a first procedure identifier of the target procedure corresponding to the target sub-procedure, a procedure parameter of the target procedure, a storage platform identifier of the target sub-procedure, a procedure engine identifier of a procedure engine for executing the target sub-procedure, a scheduling identifier of the target subtask, a trigger condition of the target subtask, a status of the target subtask, execution object information of the target subtask, a creator of the target subtask, creation time of the target subtask, or update time of the target subtask.

The scheduling identifier is used to uniquely indicate a target subtask in a process of scheduling the target subtask.

The trigger condition of the target subtask is a condition of executing the target subtask. When the trigger condition is met, the target subtask is executed; otherwise, the target subtask is not executed. The trigger condition of the target subtask is consistent with an execution condition of a corresponding target procedure.

The execution object information of the target subtask is used to indicate an execution object of the target subtask, such as a region, a scenario, or an application program, to execute the target subtask when the execution object information is met.

The status of the target subtask may include, but is not limited to: not executed, ongoing, successfully executed, or unsuccessfully executed.

In order to facilitate management on the target subtask, a target task may be set for the target procedure, and the target subtask may be understood as being obtained by splitting the target task. The attribute of the target task may include at least one of the following: a task identifier of the target task, an option/switch of the target task, a task identifier of each target subtask corresponding to the target task, a status of the target task, a maintainer of the target task, creation time of the target task, or modification time of the target task.

The option/switch of the target task is used to start or end the target task. When the option of the target task is in a starting state, the target subtask corresponding to the target task may be executed. When the option of the target task is in an end state, the target subtask corresponding to the target task is not executed.

The status of the target task includes, but is not limited to: the target task being not executed, the target task being ongoing, the target task being successfully executed, or the target task being unsuccessfully executed. The status of the target task is determined based on a status of the target subtask corresponding to the target task. When statuses of all target subtasks of the target task are statuses that the target subtasks are not executed, the status of the target task may be set to the status that the target task is not executed. When a status of at least one target subtask of the target task is the status that the target subtask is ongoing, the status of the target task may be set to the status that the target task is ongoing. When a status of at least one target subtask of the target task is the status that the target subtask is unsuccessfully executed, the status of the target task may be set to the status that the target task is unsuccessfully executed. When all target subtasks of the target task are successfully executed, the status of the target task may be set to the status that the target task is successfully executed.

In this embodiment of the present disclosure, when each target subtask is executed, for each target node in the target sub-procedure corresponding to the target subtask, a remote procedure call (RPC) interface is called by using the procedure engine to execute a processing process of the target node. The remote procedure call interface is used to call, by using a reflection mechanism (golang), a processing interface corresponding to the target node to execute the processing process of the target node, and different target nodes correspond to the same remote procedure call interface. In this case, the same remote procedure call interface may be called by using the procedure engine, to process target nodes in different systems without a need to develop a separate RPC interface for each node, thereby helping reduce development costs.

FIG. 4 is a schematic diagram of a process of generating a target procedure according to at least one embodiment of the present disclosure. As shown in FIG. 4, a template library is exemplarily provided. Templates C1 to C5 in the template library are templates that meet a preset condition and are provided for a user to select a target template. The user selects the target templates C2, C4, and C5 from the template library, and sets a sequence of the target templates to C4->C2->C5. Specifically, the user may drag the templates C2, C4, and C5 from the template library into a procedure configuration interface on the right, and sequentially connect the target templates C4, C2, and C5 by using arrows.

In FIG. 4, the user may further configure a target node corresponding to each of the target templates in the procedure configuration interface. For example, the user configures a target node B4 in a node configuration interface of the target template C4, a target node B2 in a node configuration interface of the target template C2, and a target node B5 in a node configuration interface of the target template C5.

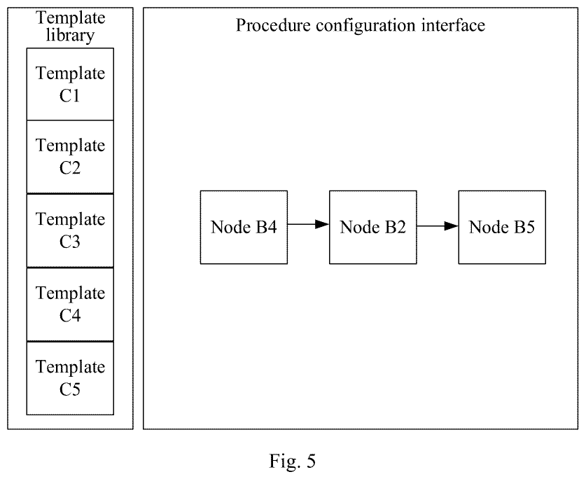

As shown in FIG. 4, the user may separately operate the target templates C4, C2, and C5 in the procedure configuration interface, to separately enter the corresponding node configuration interfaces and to complete the configuration of the corresponding target nodes. After the configuration is completed, the procedure configuration interface shown in FIG. 4 is updated to an interface shown in FIG. 5, and the generated target procedure is displayed in the interface shown in FIG. 5, including the target nodes B4, B2, and B5 that are sequentially executed.

In the procedure configuration interface shown in FIG. 4 or FIG. 5, other attributes of the procedure may be further set. After the other attributes are set, the target procedure is successfully created.

In conclusion, the procedure processing method in the embodiments of the present disclosure includes a procedure building process and a process execution process. The procedure building process may be implemented by a procedure building platform, and the procedure execution process may be implemented by a procedure execution platform. The procedure building platform is mainly used to preconfigure a template and a node configuration interface of the template, and to configure a node and a procedure. The procedure execution platform is used to call a procedure engine to execute the procedure.

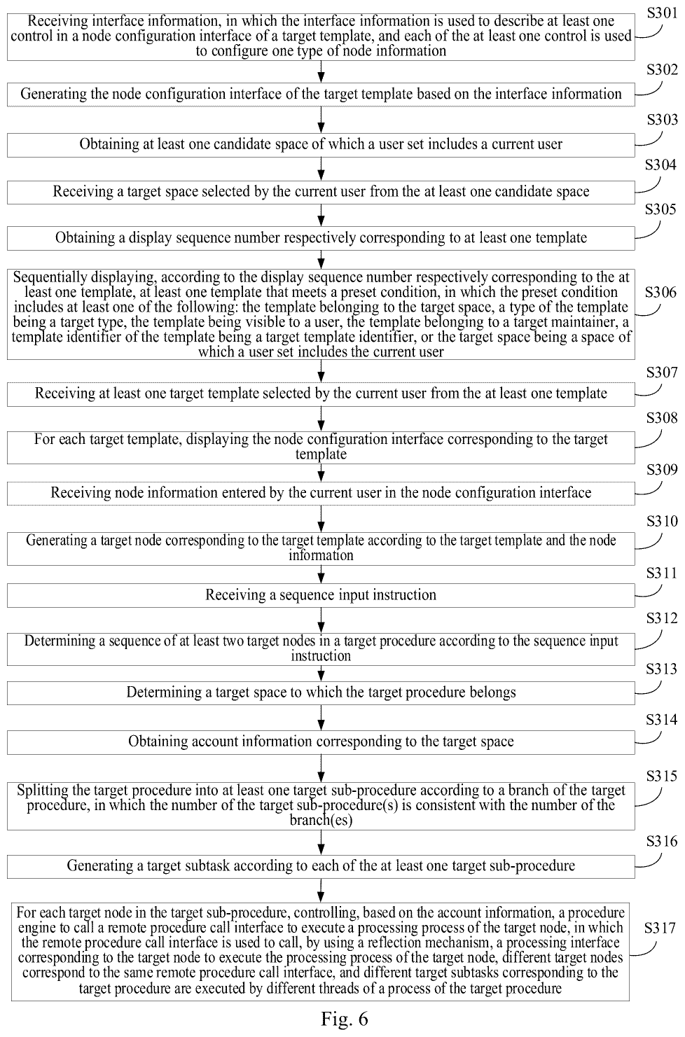

FIG. 6 is a flowchart of steps of another procedure processing method according to at least one embodiment of the present disclosure. As shown in FIG. 6, the procedure processing method may include the following steps.

S301: receiving interface information, in which the interface information is used to describe at least one control in a node configuration interface of a target template, and each of the at least one control is used to configure one type of node information.

S302: generating the node configuration interface of the target template based on the interface information.

S301 and S302 are steps of preconfiguring the node configuration interface, and need to be performed in advance.

S303: obtaining at least one candidate space of which a user set includes a current user.

S304: receiving a target space selected by the current user from the at least one candidate space.

S305: obtaining a display sequence number respectively corresponding to at least one template.

S306: sequentially display, according to the display sequence number respectively corresponding to the at least one template, at least one template that meets a preset condition, in which the preset condition includes at least one of the following: the template belonging to the target space, a type of the template being a target type, the template being visible to a user, the template belonging to a target maintainer, a template identifier of the template being a target template identifier, or the target space being a space of which a user set includes the current user.

S307: receiving at least one target template selected by the current user from the at least one template.

S308: for each target template, displaying the node configuration interface corresponding to the target template.

S309: receiving node information entered by the current user in the node configuration interface.

S310: generating a target node corresponding to the target template according to the target template and the node information.

S311: receiving a sequence input instruction.

S312: determining a sequence of at least two target nodes in a target procedure according to the sequence input instruction.

S313: determining a target space to which the target procedure belongs.

S314: obtaining account information corresponding to the target space.

S315: splitting the target procedure into at least one target sub-procedure according to a branch of the target procedure, in which the number of the target sub-procedure(s) is consistent with the number of the branch(es).

S316: generating a target subtask according to each of the at least one target sub-procedure.

S317: for each target node in the target sub-procedure, controlling, based on the account information, a procedure engine to call a remote procedure call interface to execute a processing process of the target node, in which the remote procedure call interface is used to call, by using a reflection mechanism, a processing interface corresponding to the target node to execute the processing process of the target node, different target nodes correspond to the same remote procedure call interface, and different target subtasks corresponding to the target procedure are executed by different threads of a process of the target procedure.

It should be noted that a sequence of the steps shown in FIG. 6 may be flexibly adjusted based on mutual independence. In addition, for the above procedure processing method, refer to the corresponding description of the procedure processing method shown in FIG. 2. Details are not described herein again.

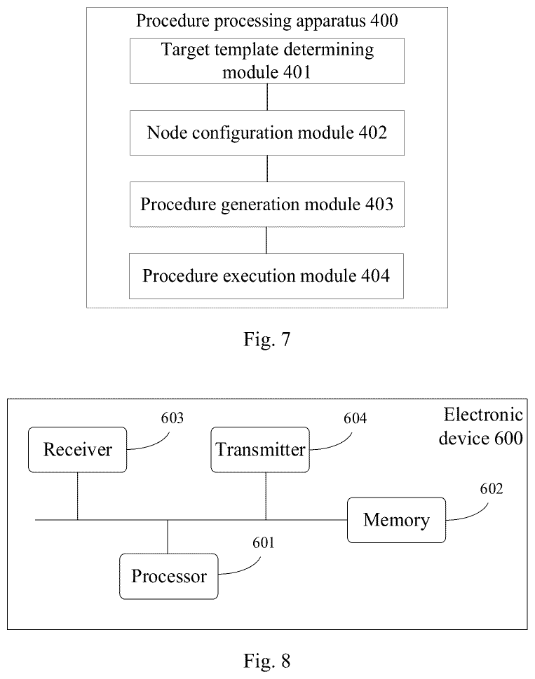

Corresponding to the procedure processing method in the above embodiments, FIG. 7 is a block diagram of a structure of a procedure processing apparatus according to at least one embodiment of the present disclosure. For ease of illustration, only parts related to this embodiment of the present disclosure are shown. As shown in FIG. 7, the procedure processing apparatus 400 includes:
a target template determining module 401, configured to determine at least two target templates;
a node configuration module 402, configured to configure, by using node configuration interfaces respectively corresponding to the target templates, target nodes respectively corresponding to the target templates;
a procedure generation module 403, configured to generate a target procedure based on at least two target nodes; and
a procedure execution module 404, configured to execute the target procedure by using a procedure engine.

Optionally, the target template determining module 401 is further configured to:
display at least one template that meets a preset condition, in which the preset condition includes at least one of the following: the template belonging to a target space, a type of the template being a target type, the template being visible to a user, the template belonging to a target maintainer, a template identifier of the template being a target template identifier, or the target space being a space of which a user set includes a current user; and receive at least one target template selected by the current user from the at least one template.

Optionally, the target template determining module 401 is further configured to:
obtain a display sequence number respectively corresponding to the at least one template; and sequentially display the at least one template based on the display sequence number respectively corresponding to the at least one template.

Optionally, the target template determining module 401 is further configured to:
obtain at least one candidate space of which a user set includes the current user; and receive the target space selected by the current user from the at least one candidate space.

Optionally, the apparatus further includes:
an information receiving module, configured to receive interface information before the at least two target templates are determined, in which the interface information is used to describe at least one control in the node configuration interface of the target template, and each of the at least one control is used to configure one type of node information; and
an interface configuration module, configured to generate the node configuration interface of the target template based on the interface information.

Optionally, the node configuration module 402 is further configured to:
for each of the target templates, display the node configuration interface corresponding to the target template; receive node information entered by a current user in the node configuration interface; and generate the target node corresponding to the target template based on the target template and the node information.

Optionally, the procedure generation module 403 is further configured to:
receive a sequence input instruction; and determine a sequence of the at least two target nodes in the target procedure based on the sequence input instruction.

Optionally, the procedure execution module 404 is further configured to:
determine a target space to which the target procedure belongs; obtain account information corresponding to the target space; and call the procedure engine through the account information to run the target procedure.

Optionally, the procedure execution module 404 is further configured to:
split the target procedure into at least one target sub-procedure based on a branch of the target procedure, in which the number of the target sub-procedure(s) is consistent with the number of the branch(es); generate a target subtask based on each of the at least one target sub-procedure; and execute the target subtask by using the procedure engine, in which different target subtasks corresponding to the target procedure are executed by different threads of a process of the target procedure.

Optionally, the target subtask is used to sequentially execute processing processes of nodes in the target sub-procedure, and the procedure execution module 404 is further configured to:
for each target node in the target sub-procedure, call, by using the procedure engine, a remote procedure call interface to execute a processing process of the target node, in which the remote procedure call interface is used to call, by using a reflection mechanism, a processing interface corresponding to the target node to execute the processing process of the target node, and different target nodes correspond to the same remote procedure call interface.

The procedure processing apparatus provided in this embodiment may be configured to perform the technical solution in the above embodiment of the procedure processing method. Implementation principles and technical effects of the apparatus and the method are similar. Details are not described in this embodiment again.

FIG. 8 is a block diagram of a structure of an electronic device according to at least one embodiment of the present disclosure. The electronic device 600 includes a memory 602 and at least one processor 601.

The memory 602 stores computer-executable instructions.

The at least one processor 601 executes the computer-executable instructions stored in the memory 602, to cause the electronic device 600 to implement the above procedure processing method.

In addition, the electronic device may further include a receiver 603 and a transmitter 604. The receiver 603 is configured to receive information from other apparatuses or devices and forward the information to the processor 601. The transmitter 604 is configured to transmit information to other apparatuses or devices.

In a first example of a first aspect, at least one embodiment of the present disclosure provides a procedure processing method. The method includes:
determining at least two target templates;
configuring, by using node configuration interfaces respectively corresponding to the target templates, target nodes respectively corresponding to the target templates;
generating a target procedure based on at least two target nodes; and executing the target procedure by using a procedure engine.

Based on the first example of the first aspect, in a second example of the first aspect, the determining at least two target templates includes:
displaying at least one template that meets a preset condition, in which the preset condition includes at least one of the following: the template belonging to a target space, a type of the template being a target type, the template being visible to a user, the template belonging to a target maintainer, a template identifier of the template being a target template identifier, or the target space being a space of which a user set includes a current user; and receiving at least one target template selected by the current user from the at least one template.

Based on the second example of the first aspect, in a third example of the first aspect, the displaying at least one template that meets a preset condition includes:
obtaining a display sequence number respectively corresponding to the at least one template; and sequentially displaying the at least one template based on the display sequence number respectively corresponding to the at least one template.

Based on the second example of the first aspect, in a fourth example of the first aspect, a process of determining the target space includes:
obtaining at least one candidate space of which a user set includes the current user; and receiving the target space selected by the current user from the at least one candidate space.

Based on the first example of the first aspect, in a fifth example of the first aspect, before the determining at least two target templates, the method further includes:
receiving interface information, in which the interface information is used to describe at least one control in the node configuration interface of the target template, and each of the at least one control is used to configure one type of node information; and generating the node configuration interface of the target template based on the interface information.

Based on the first example of the first aspect, in a sixth example of the first aspect, the configuring, by using node configuration interfaces respectively corresponding to the target templates, target nodes respectively corresponding to the target templates includes:
for each of the target templates, displaying the node configuration interface corresponding to the target template; receiving node information entered by a current user in the node configuration interface; and generating the target node corresponding to the target template based on the target template and the node information.

Based on the first example of the first aspect, in a seventh example of the first aspect, the generating a target procedure based on the at least two target nodes includes:
receiving a sequence input instruction; and determining a sequence of the at least two target nodes in the target procedure based on the sequence input instruction.

Based on the first example of the first aspect, in an eighth example of the first aspect, the executing the target procedure by using a procedure engine includes:
determining a target space to which the target procedure belongs; obtaining account information corresponding to the target space; and calling the procedure engine through the account information to run the target procedure.

Based on the eighth example of the first aspect, in a ninth example of the first aspect, the calling the procedure engine to run the target procedure includes:
splitting the target procedure into at least one target sub-procedure based on a branch of the target procedure, in which the number of the target sub-procedure(s) is consistent with the number of the branch(es); generating a target subtask based on each of the at least one target sub-procedure; and executing the target subtask by using the procedure engine, in which different target subtasks corresponding to the target procedure are executed by different threads of a process of the target procedure.

Based on the ninth example of the first aspect, in a tenth example of the first aspect, the target subtask is used to sequentially execute processing processes of nodes in the target sub-procedure, and the executing the target subtask by using the procedure engine includes:
for each target node in the target sub-procedure, calling, by using the procedure engine, a remote procedure call interface to execute a processing process of the target node, in which the remote procedure call interface is used to call, by using a reflection mechanism, a processing interface corresponding to the target node to execute the processing process of the target node, and different target nodes correspond to the same remote procedure call interface.

In a first example of a second aspect, a procedure processing apparatus is provided. The apparatus includes:
a target template determining module, configured to determine at least two target templates;
a node configuration module configured to, configure, by using node configuration interfaces respectively corresponding to the target templates, target nodes respectively corresponding to the target templates;
a procedure generation module, configured to generate a target procedure based on at least two target nodes; and
a procedure execution module, configured to execute the target procedure by using a procedure engine.

Based on the first example of the second aspect, in a second example of the second aspect, the target template determining module is further configured to:
display at least one template that meets a preset condition, in which the preset condition includes at least one of the following: the template belonging to a target space, a type of the template being a target type, the template being visible to a user, the template belonging to a target maintainer, a template identifier of the template being a target template identifier, or the target space being a space of which a user set includes a current user; and receive at least one target template selected by the current user from the at least one template.

Based on the second example of the second aspect, in a third example of the second aspect, the target template determining module is further configured to:
obtain a display sequence number respectively corresponding to the at least one template; and sequentially display the at least one template based on the display sequence number respectively corresponding to the at least one template.

Based on the second example of the second aspect, in a fourth example of the second aspect, the target template determining module is further configured to:
obtain at least one candidate space of which a user set includes the current user; and receive the target space selected by the current user from the at least one candidate space.

Based on the first example of the second aspect, in a fifth example of the second aspect, the apparatus further includes:
an information receiving module, configured to receive interface information before the at least two target templates are determined, in which the interface information is used to describe at least one control in the node configuration interface of the target template, and each of the at least one control is used to configure one type of node information; and
an interface configuration module, configured to generate the node configuration interface of the target template based on the interface information.

Based on the first example of the second aspect, in a sixth example of the second aspect, the node configuration module is further configured to:
for each of the target templates, display the node configuration interface corresponding to the target template; receive node information entered by a current user in the node configuration interface; and generate the target node corresponding to the target template based on the target template and the node information.

Based on the first example of the second aspect, in a seventh example of the second aspect, the procedure generation module is further configured to:
receive a sequence input instruction; and determine a sequence of the at least two target nodes in the target procedure based on the sequence input instruction.

Based on the first example of the second aspect, in an eighth example of the second aspect, the procedure execution module is further configured to:
determine a target space to which the target procedure belongs; obtain account information corresponding to the target space; and call the procedure engine through the account information to run the target procedure.

Based on the eighth example of the second aspect, in a ninth example of the second aspect, the procedure execution module is further configured to:
split the target procedure into at least one target sub-procedure based on a branch of the target procedure, in which the number of the target sub-procedure(s) is consistent with the number of the branch(es); generate a target subtask based on each of the at least one target sub-procedure; and execute the target subtask by using the procedure engine, in which different target subtasks corresponding to the target procedure are executed by different threads of a process of the target procedure.

Based on the ninth example of the second aspect, in a tenth example of the second aspect, the target subtask is used to sequentially execute processing processes of nodes in the target sub-procedure, and the procedure execution module is further configured to:
for each target node in the target sub-procedure, call, by using the procedure engine, a remote procedure call interface to execute a processing process of the target node, in which the remote procedure call interface is used to call, by using a reflection mechanism, a processing interface corresponding to the target node to execute the processing process of the target node, and different target nodes correspond to the same remote procedure call interface.

In a third aspect, according to one or more embodiments of the present disclosure, an electronic device is provided, the device includes: at least one processor and a memory.

The memory stores computer-executable instructions.

The at least one processor executes the computer-executable instructions stored in the memory, to cause the electronic device to implement the procedure processing method of any one of the embodiments of the first aspect.

In a fourth aspect, according to one or more embodiments of the present disclosure, a computer-readable storage medium is provided. The computer-readable storage medium stores computer-executable instructions, when the computer-executable instructions are executed by a processor, a computing device is caused to implement the procedure processing method of any one of the embodiments of the first aspect.

In a fifth aspect, according to one or more embodiments of the present disclosure, a computer program product is provided, the product includes a computer program, when the computer program is executed by a processor, the procedure processing method of any one of the embodiments of the first aspect is implemented.

The above descriptions are merely preferred embodiments of the present disclosure and explanations of the applied technical principles. Those skilled in the art should understand that the scope of disclosure involved in the present disclosure is not limited to the technical solutions formed by specific combinations of the above technical features, and shall also cover other technical solutions formed by any combination of the above technical features or equivalent features thereof without departing from the above concept of disclosure. For example, a technical solution formed by a replacement of the above features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the above discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A procedure processing method, comprising:
determining at least two target templates;
configuring, by using node configuration interfaces respectively corresponding to the target templates, target nodes respectively corresponding to the target templates;
generating a target procedure based on at least two target nodes; and
executing the target procedure by using a procedure engine.

2. The method according to claim 1, wherein the determining at least two target templates comprises:
displaying at least one template that meets a preset condition, wherein the preset condition comprises at least one of following: the template belonging to a target space, a type of the template being a target type, the template being visible to a user, the template belonging to a target maintainer, a template identifier of the template being a target template identifier, or the target space being a space of which a user set comprises a current user; and
receiving at least one target template selected by the current user from the at least one template.

3. The method according to claim 2, wherein the displaying at least one template that meets a preset condition comprises:
obtaining a display sequence number respectively corresponding to the at least one template; and
sequentially displaying the at least one template based on the display sequence number respectively corresponding to the at least one template.

4. The method according to claim 2, wherein a process of determining the target space comprises:
obtaining at least one candidate space of which a user set comprises the current user; and
receiving the target space selected by the current user from the at least one candidate space.

5. The method according to claim 1, wherein before the determining at least two target templates, the method further comprises:
receiving interface information, wherein the interface information is used to describe at least one control in the node configuration interface of the target template, and each of the at least one control is used to configure one type of node information; and
generating the node configuration interface of the target template based on the interface information.

6. The method according to claim 1, wherein the configuring, by using node configuration interfaces respectively corresponding to the target templates, target nodes respectively corresponding to the target templates comprises:
for each of the target templates, displaying the node configuration interface corresponding to the target template;
receiving node information entered by a current user in the node configuration interface; and
generating the target node corresponding to the target template based on the target template and the node information.

7. The method according to claim 1, wherein the generating a target procedure based on the at least two target nodes comprises:
receiving a sequence input instruction; and
determining a sequence of the at least two target nodes in the target procedure based on the sequence input instruction.

8. The method according to claim 1, wherein the executing the target procedure by using a procedure engine comprises:
determining a target space to which the target procedure belongs;
obtaining account information corresponding to the target space; and
calling the procedure engine through the account information to run the target procedure.

9. The method according to claim 8, wherein the calling the procedure engine to run the target procedure comprises:
splitting the target procedure into at least one target sub-procedure based on a branch of the target procedure, wherein a total number of the target sub-procedure is consistent with a total number of the branch;
generating a target subtask based on each of the at least one target sub-procedure; and
executing the target subtask by using the procedure engine, wherein different target subtasks corresponding to the target procedure are executed by different threads of a process of the target procedure.

10. The method according to claim 9, wherein the target subtask is used to sequentially execute processing processes of nodes in the target sub-procedure, and the executing the target subtask by using the procedure engine comprises:
for each target node in the target sub-procedure, calling, by using the procedure engine, a remote procedure call interface to execute a processing process of the target node, wherein the remote procedure call interface is used to call, by using a reflection mechanism, a processing interface corresponding to the target node to execute the processing process of the target node, and different target nodes correspond to a same remote procedure call interface.

11. An electronic device, comprising: at least one processor and a memory,
wherein the memory stores computer-executable instructions; and
the at least one processor executes the computer-executable instructions stored in the memory, to cause the electronic device to:
determine at least two target templates;
configure, by using node configuration interfaces respectively corresponding to the target templates, target nodes respectively corresponding to the target templates;
generate a target procedure based on at least two target nodes; and
execute the target procedure by using a procedure engine.

12. A non-transitory computer-readable storage medium, storing computer-executable instructions, wherein when the computer-executable instructions are executed by a processor, a computing device is caused to implement a procedure processing method, the method comprises:
determining at least two target templates;
configuring, by using node configuration interfaces respectively corresponding to the target templates, target nodes respectively corresponding to the target templates;
generating a target procedure based on at least two target nodes; and
executing the target procedure by using a procedure engine.

13. The electronic device according to claim 11, wherein the electronic device is further caused to:
display at least one template that meets a preset condition, wherein the preset condition comprises at least one of following: the template belonging to a target space, a type of the template being a target type, the template being visible to a user, the template belonging to a target maintainer, a template identifier of the template being a target template identifier, or the target space being a space of which a user set comprises a current user; and
receive at least one target template selected by the current user from the at least one template.

14. The electronic device according to claim 13, wherein the electronic device is further caused to:
obtain a display sequence number respectively corresponding to the at least one template; and
sequentially display the at least one template based on the display sequence number respectively corresponding to the at least one template.

15. The electronic device according to claim 13, wherein the electronic device is further caused to:
obtain at least one candidate space of which a user set comprises the current user; and
receive the target space selected by the current user from the at least one candidate space.

16. The electronic device according to claim 11, wherein before the determining at least two target templates, the electronic device is further caused to:
receive interface information, wherein the interface information is used to describe at least one control in the node configuration interface of the target template, and each of the at least one control is used to configure one type of node information; and
generate the node configuration interface of the target template based on the interface information.

17. The electronic device according to claim 11, wherein the electronic device is further caused to:
for each of the target templates, display the node configuration interface corresponding to the target template;
receive node information entered by a current user in the node configuration interface; and
generate the target node corresponding to the target template based on the target template and the node information.

18. The electronic device according to claim 11, wherein the electronic device is further caused to:
receive a sequence input instruction; and
determine a sequence of the at least two target nodes in the target procedure based on the sequence input instruction.

19. The electronic device according to claim 11, wherein the electronic device is further caused to:
determine a target space to which the target procedure belongs;
obtain account information corresponding to the target space; and
call the procedure engine through the account information to run the target procedure.

20. The electronic device according to claim 19, wherein the electronic device is further caused to:
split the target procedure into at least one target sub-procedure based on a branch of the target procedure, wherein a total number of the target sub-procedure is consistent with a total number of the branch;
generate a target subtask based on each of the at least one target sub-procedure; and
execute the target subtask by using the procedure engine, wherein different target subtasks corresponding to the target procedure are executed by different threads of a process of the target procedure.
